(19) United States
(12) Patent Application Publication
(10) Pub. No.: US 2008/0092382 A1
(43) Pub. Date: Apr. 24, 2008

(54) HYDRAULIC END HEAD WITH INTERNALLY CAST HYDRAULIC CIRCUITS

(76) Inventors: Donald E. Blackman, Tinley Park, IL (US); Douglas P. Miller, New Berlin, WI (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/957,011

(22) Filed: Dec. 14, 2007

Related U.S. Application Data
(62) Division of application No. 10/741,442, filed on Dec. 22, 2003.

(51) Int. Cl. B21D 51/00; B21D 39/03; B23P 15/00; B23P 17/00

(52) U.S. Cl. 29/888; 29/428; 29/890.127

(57) ABSTRACT

A fluid manifold such as an end head for a hydraulic power pack is manufactured by providing at least one piece of tubing into a mold and molding a material to form a block around the tubing, resulting in a manifold block that has tubing arranged inside to form fluid circuitry. Additional conduits and mounting points for componentry such as valves and fittings may be machined into the block in fluid connection with the tubing conduits.

### CROSS-REFERENCE TO RELATED APPLICATIONS

This divisional application claims priority of U.S. patent application Ser. No. 10/741,442, filed Dec. 22, 2007, the disclosure of which is incorporated herein by reference in its entirety.

### FIELD OF THE INVENTION

The invention relates to hydraulic systems, and more particularly to manifolds used in hydraulic system, such as for example manifolds provided in end heads of hydraulic power systems.

### BACKGROUND OF THE INVENTION

Hydraulic power systems including hydraulic power packs are in wide use in industry. For example, hydraulic power packs are often used to provide hydraulic power to rams, hoists and other operative devices to lift support, move or otherwise provide force to various items. One typical type of hydraulic power pack utilizes a so-called “end head” which provides a means for attachment of a motor on one side of the end head to a pump/reservoir tank assembly on the other side of the end head. Power is transmitted from the motor shaft of the pump through a clearance in the end head and the end head block itself also provides a convenient location for a manifold which has fluid conduits that can include the fluid return conduits into the pump/tank, as well as the fluid power outlet port and associated operation componentry such as valves, check valves, over pressure valves, and the like.

In the prior art, it has been known to form the end head as a relatively thick slab-like block having relatively flat opposed sides that are bolted against the motor and against the tank and pump assembly, respectively. Various ports are provided around the peripheral sides of the end head block which lead to various conduits that provide for fluid circuit pathways through the block connecting various conduits and valves.

The conventional prior art process for manufacturing end heads has included first machining a solid block of ductile iron or aluminum having the desired outside shape. Next, the fluid ports and fluid passageways are manufactured essentially by drilling into the block from the outside periphery of the block. Where a return-to-tank passageway is desired, typically that passageway is drilled into the face of the block that would face the tank/pump assembly. Similarly, from-the-pump inlet port is also usually drilled into the face of the block which abuts directly against the pump. The various circuit passageways desired can sometimes be quite complex in their arrangement.

The above described prior art method of manufacturing end heads has some disadvantages, however. For example, the drilling of various straight bores in order to form complex circuit paths often entails the removal and hence the waste of some of the block material. Often, due to the limitations of drilling straight bores into the sides of the end head blocks, where a passage is to have an internal corner it is necessary to do quite a bit of extra drilling of holes which then need to be capped with an end cap. Also, since virtually every passageway is created by drilling, quite a bit of wear on tools can be involved. Also, because the passages are essentially constrained into being straight lines formed by drill bits, the corners where a change in direction of the passages typically occurs as a right angle corner, which may not be the most desirable flow path with regard to factors such as turbulence and pressure loss. Further, where a passage is drilled and then needs to be capped, additional componentry for the capping process must be used which adds costs and assembly steps.

Another a disadvantage of the above described known end heads is that the use of ductile iron or solid aluminum blocks as the starting base typically causes the end heads to be relatively heavy in weight. The heavy weight of the end heads is undesirable for manufacturing and transport, and is further undesirable since power packs are often mounted off the floor, for example by being suspended vertically on walls or other vertical surfaces, or by being mounted on vehicles. Portability is also desirable in some power packs, which provides a desirable opportunity for a lighter end head configuration.

Accordingly, there is a need in the art for an end head component, and method for making an end head component, that allows for desirable manifold circuit and componentry features in the end head, while also being economical and lightweight at least to some extent.

### SUMMARY OF THE INVENTION

The foregoing needs are met, to a great extent, by the present invention, wherein in some embodiments, an end head and a method for making an end head are provided.

In accordance with one embodiment of the present invention, a fluid manifold comprises a molded block, and at least one piece of tubing molded into the block and defining at least one fluid conduit inside the block.

In accordance with another embodiment of the present invention, a fluid manifold comprises a molded block, and means for defining at least one fluid conduit inside the block, having at least one piece of tubing molded into the block.

In accordance with yet another embodiment of the present invention, a method for manufacturing a fluid manifold comprises providing at least one piece of tubing in a mold, and molding a material into a block around the tubing so that a fluid conduit is formed by the tubing in the block.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a side view of a hydraulic power pack including an end head according to the present invention.

FIG. 2 is a top view of the power pack of FIG. 1.

FIG. 3 is a end view taken through line 3-3 in FIG. 2.

FIG. 4 is a cross sectional view of an end head taken through line 4-4 in FIG. 2.

FIG. 5 is a cross sectional view diagrammatically illustrating a process of manufacture of the end head of FIG. 4, showing an overlay of a round tubing arrangement onto a conventional end head for representational purposes.

FIG. 6 is a cross sectional view of an alternative end head arrangement formed in accordance with an embodiment of the present invention.

FIG. 7 is a cross sectional view diagrammatically illustrating a process of manufacture of the end head of FIG. 6, showing an overlay of a round tubing arrangement onto a conventional end head for representational purposes.

### DETAILED DESCRIPTION

The foregoing needs are met, to a great extent, by the present invention, wherein in some embodiments, an end head and a method for making an end head are provided. One aspect of some embodiments of the invention is that at least some of the conduits in the end head are initially formed as bent tubing which is held in place during a molding manufacture of the end head block around the tubing. As a result of the molding of the end head block with the tubes inserted therein, passageways corresponding to the shape of the tubing, and having their outside walls defined by the tubing, are provided in desired locations through the end head block.

The tubing can reach the surface of the end head block to form ports, possibly with some tubing extended outward from the block to some degree immediately after the molding stage. At this point, the excess tubing extending outward from the block can be removed, and further port attachment threads can be drilled and tapped at the desired location of the ports. In addition, componentry such as operational valves, check valves and over pressure valves can be added to interact with the conduits at this stage so that the valves intersect with the conduits. Benefits of using tubing to form some or all of the conduit passageways include the ability to provide gradually curved directional changes in the conduit when bent tubing is used. Tubing also provides the ability to provide changing diameters of the conduits along their length, and the ability to have the conduit walls which interact with the pressurized fluid be made of the tubing material, which may have more desirable properties for this purpose then the material of the end head block itself. In many instances the process of molding around tubing results in a reduction in manufacturing costs.

It will also be appreciated that the material from which the block is molded is not directly subjected to the fluid pressure in the tubular conduits and thus if the tubing is of sufficient thickness, the block molding material be selected to be a material that have other desirable properties, for example such as being light weight. Preferred materials for molding the block around the tubing are described in more detail below.

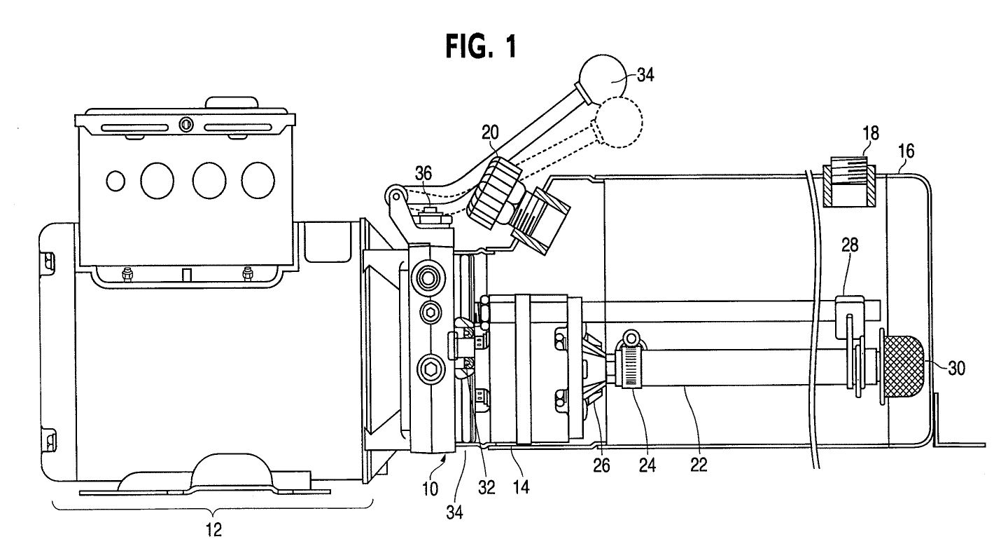

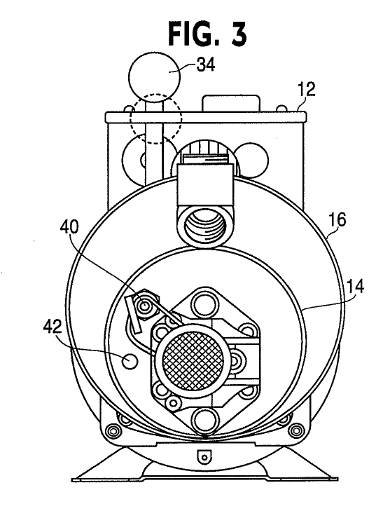

Preferred embodiments of the invention will now be further described with further reference to the drawing figures in which like reference numerals to like parts throughout. Referring now to FIGS. 1, 2 and 3, an end head 10 is provided for connecting a motor 12 to a pump 14 and hydraulic tank 16, all forming a power pack arrangement. Since the illustrated exemplary power pack arrangement is for vertical mounting, the tank 16 is configured to have a drain plug 18 and a filler port cap 20 where shown. The pump 14 draws fluid from the oil tank 16 through an inlet assembly tube 22 attached by a band clamp 24 to a suction cover 26 of the pump 14. The suction cover 26 provides the means for fluid to enter the pump 14 for pressurization. The inlet tube 22 is also associated with a magnet 28 for attracting metallic and a filter 30 for filtering the hydraulic oil or other fluid as it enters the inlet tubing 22. The pump 14 may be any suitable hydraulic pump such as for example a gear pump.

The motor 12 has a splined output shaft which drives a similarly splined input shaft of the pump 14. Both splined shafts are connected by extending through a bore in the end head 10, preferably by a splined connection which is free to rotate through the central bore of the intake 10.

A seal 32 may be provided to seal the central bore to prevent leakage of fluid towards the motor, and an O-ring 34 may be provided to seal the end of the fluid tank 16 against the adjacent surface of the end head 10.

As will be described in more detail below, a handle 34 is provided to provide mechanical leverage against a operation valve 36. The pump 14 is configured to provide pressure into a port (not shown in FIGS. 1-3), on the end head and to accept return flow through one or more return flow ports 40 and 42 which are provided in the pump-facing surface of the end head 10.

The components illustrated in FIGS. 1-3, except for the end head 10, are conventional and known in the art. However, the end head 10 according to this embodiment differs from the prior art end head arrangements in at least one of several ways, including for example its internal structure, its material, and its method of manufacture.

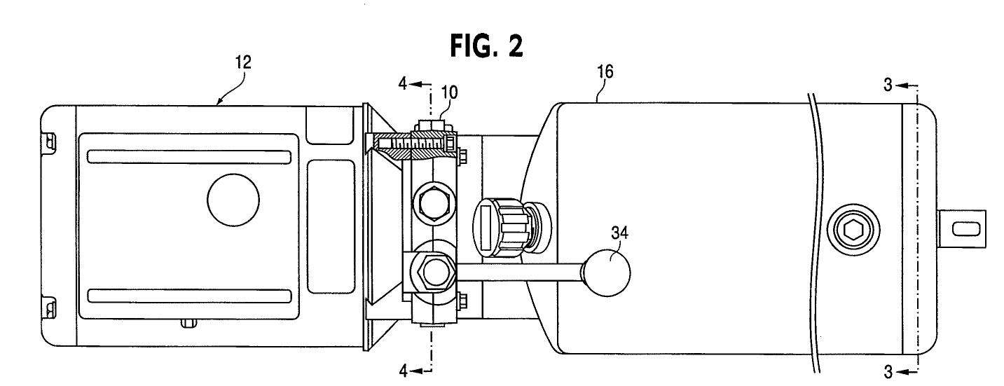

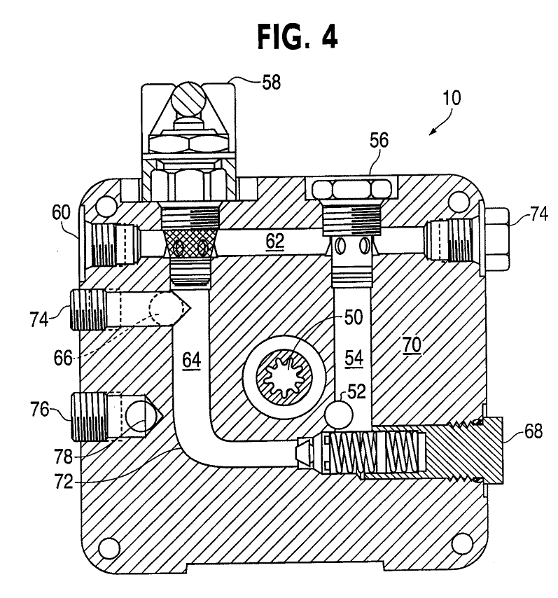

Turning now to FIG. 4, a cross section of an end head 10 according to the preferred embodiment of the present invention is illustrated. FIG. 4 illustrates a cross sectional view of the end head 10 taken through line 4-4 in FIG. 2. The end head 10 includes a central coupling piece 50 which is shown as a separate component surrounded by a clearance in a bore of the end head 16. The coupling 50 has internal splines which meet with splines on the drive shafts of the motor and pump, respectively, so that power can be transmitted through the end head 10 by rotation of the spline coupling 50. The pump 14 supplies fluid under pressure into an inlet port 52 which is indicated by a circle in the illustration. The inlet 52 is a port extending perpendicular to the direction of the drawing and out the surface of the end head 10 that faces the pump 14. Thus, pressure generated by the pump 14 enters a conduit the end head by passing into the inlet port 52 represented by the circle 52. The pressurized fluid is then normally supplied to a conduit 54 which has been formed by tubing as described herein.

The completed end head 10 has a check valve 56 and has been installed into a drilled and threaded bore socket that has been drilled from the outside edge of the end head 10 after it has been molded. The end head 10 also includes a operational valve 58 which in this embodiment is a normally closed two-position manually operable valve. In the normally closed position, the operational valve 50 permits flow only out through the working port 60. The valve 58 is installed into a drilled and threaded bore socket that is drilled into the block after it has been molded at the location of where the tube is extending outward out of the block. Similarly, an outlet port 60 has a machined shape for attachment to a pressure line. The outlet, or “working” port 60, provides the high pressure outlet flow and is connected to a line providing pressure to the cylinder of the actuating cylinder or ram or other hydraulic component to be actuated.

When the operational valve 58 is in its normally closed position, fluid flows through the conduit 62 and out the outlet port 60 and is prevented from entering the return conduit 64. When the valve is manually moved to an open position, fluid is permitted to flow into the conduit 64 so that the excess pressure fluid can be returned to tank port 66.

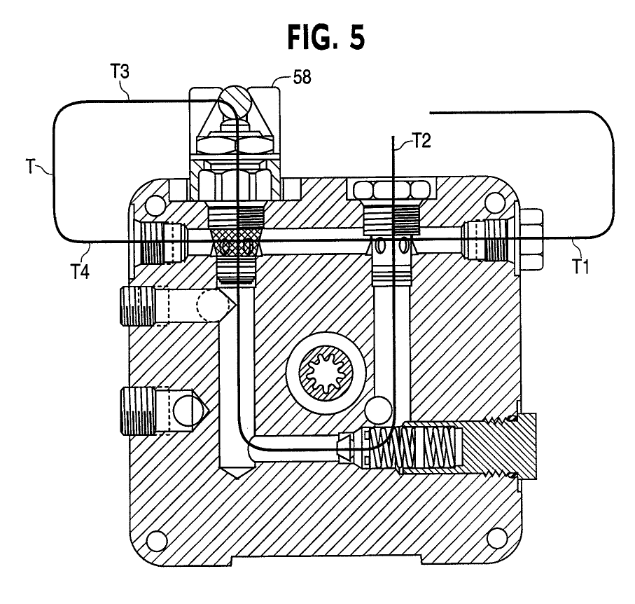

In one aspect of this exemplary preferred embodiment, the side walls of the conduits 54, 62 and 64 respectively are formed by tubing which was inserted into a mold for the end head block with the material 70 of the end head block molded around the tube. One benefit of this can be seen for example in the radiused curvature 72 indicated at a portion of conduit 64. In the preferred embodiment, a cap 74 is provided at an end of conduit 62 where tubing had originally exited the molded block 70. As will be described in more detail with respect to FIG. 5, conduits 54 and 62 were fashioned from tubes that did not actually intersect each other, but which crossed each other while substantially adjacent to each other at their point of intersection has seen in this drawing view. The drilling process for the insertion of check valve 56 is with a large enough diameter so that if the tube for conduit 54 and a tube for conduit 62 are interconnected by the hole that is drilled for the check valve 56 and subsequently by the inserted valve 56 so that the conduits 54 and 62 do have fluid connection with each other through the check valve 56.

The embodiment of FIG. 4 also illustrates a optional return-to-tank fitting location 74 which can be provided for additional return of the fluid from the actuator to the tank 16 as well as an optional return-to-tank fitting location 76 which has its own return to tank port 78 for the return of fluid from some other source when desired. In the illustrated embodiment, the ports 74, 76 and 78 have been manufactured using conventional drilling techniques.

The heavy line labeled T shows the shape of the center line of the bent tubing that is used to form the corresponding conduits shown in FIG. 4. Thus, to form the embodiment of FIG. 4, the first step is the placing of the tubing having its center line labeled T into a mold having an outer shape similar to the outer shape of the desired end head 10. Next, a mold material is molded and formed and solidified in the mold around the tubing. When the end head 10 is removed, portions of the tubes labeled T1, T2 and T3 and T4 will be extending outside the side edges of the molded block. The extending tubular material can be cut off with conventional cutters. A procedure of drilling will effectively remove the tubing walls up to the depth that is drilled and permit the threaded insertion of the appropriate valves, fittings and/or caps.

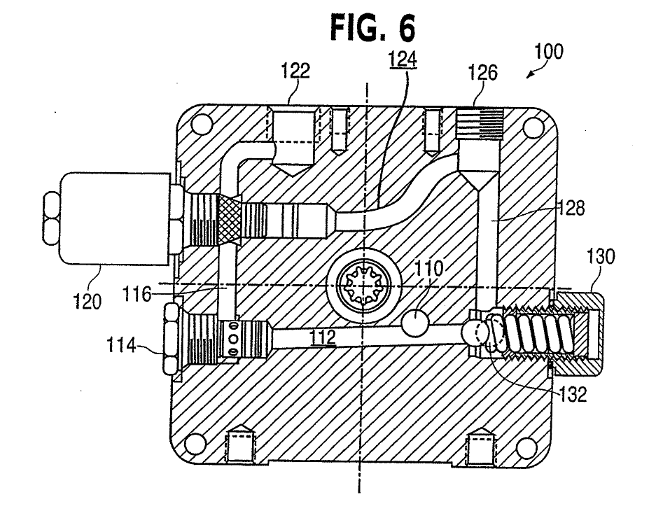

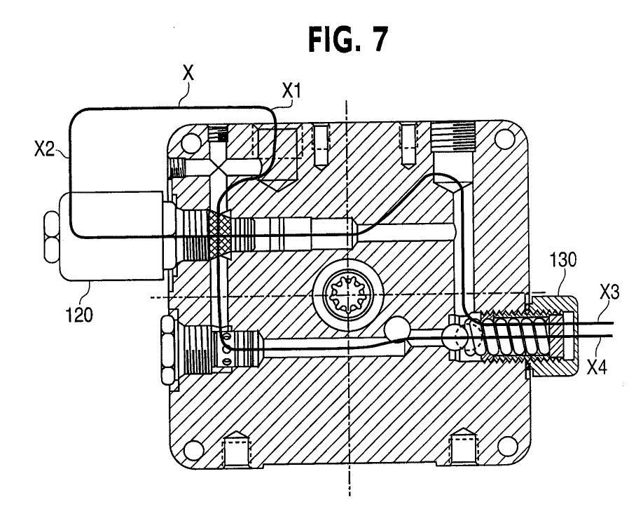

FIGS. 6 and 7 illustrate an alternative configuration of an end head 100. This end head 100 includes an inlet port 110 leading to a conduit 112 which has been formed by a tube which leads to a check valve 114, further leading to a conduit 116 which leads to the manual release valve 120 which in this embodiment is a flow control valve as opposed to an on/off valve as in the embodiment in FIG. 4. The fluid power output location is at 122 when the valve 120 is closed. When the valve 120 is open, fluid is directed through a conduit 124 that has been formed by a tube, which leads to a second return inlet fitting 126 which has been formed by the conventional drilling process intersection, into the tube which forms the conduit 124 and these lead to a conduit 126 which is also formed with the tubular walls. The conduit 126 leads to a relief valve 130 which in the illustrated embodiment is an adjustable relief valve. When the relief valve 130 is subjected to a sufficient pressure allows relief flow back to the tank and through a port 132. The inlet port 110 and return-to-tank port 132 are drilled perpendicularly to the overall conduit plan in a fashion similar to the ports 52 and 66 of the embodiment of FIG. 4 respectively.

FIG. 7 is a view of the type similar to FIG. 5 showing a tubing generally designated X which has portions X1, X2, X3 and X4 extending out the initially molded block. In the view shown, the tubes cross each other at the location of the operating valve 120 and when drilling is performed to provide the mounting location for 120 a fluid connection is provided between conduits 116 and 124 through the valve 120. With regard to the tube extensions X3 and X4, these two tubes run parallel to each other and adjacent to each other in such a way that the drilling for the installation of the relief valve 130 is of such diameter to put both tubes in fluid communication via the installation of the relief valve so that conduits 126 and 112 are in fluid communication through the relief valve.

The embodiments of FIG. 4 and FIG. 6 are described for illustrative purposes only, to give examples of sample configurations of circuitry and associated components and ports that can be provided by molding a block around tubing to form an end head. In various embodiments, a single bent tube having a complex shape may be utilized, or several individual tubes each having a respective straight or bent shape may be used. Further, the tubes may extend outward from the sides or other parts of the end head by any amount. In most cases it is preferred that the tubes do not themselves become filled with material during the molding process. However, where it is desirable to embed a part of a tube inside the block but have it not extend outward from the block during molding the tube may have its open end presealed in some fashion.

The tubes may be selected from any suitable material, and factors involving the selection of tubing material may include the tube's formability, cost, suitability for use with the hydraulic fluid involved, machining ability, the use of removal when drilled, and the tubing material's ability to bond with the surrounding molded material. Plain steel tubing is preference in some embodiments. The molding material that is molded around the tubing may also be selected from any suitable material, and in a preferred embodiment may include a cast aluminum using an aluminum casting process from the Contech® company. The tubing is preferably relatively this wall steel tubing. If molding pressures thereafter to deform the tubing, the tubing can be internally pressurized to retain its shape during molding. Also, optionally a mechanical on metallurgical bond can be formed between the tubing and the block during molding, for example by coating the tubing with epoxy before molding or by surface treating the tubing such as by measuring it.

It will be appreciated that some embodiments of the present invention provide the ability to manufacture a manifold wherein some or all of internal passages are formed by tubes having a structural material molded in a block (or inside the block) that other suitable shape around the tubes. Componentry such as fittings and valves around the periphery of the block to connect to the tubes may be formed by typical machining processes and subsequently installed, and additional passages may also be machined as desired. In addition, in alternative embodiments, the valves or fittings or other components may be preattached to the tubing before the material is molded. For example, in an alternative embodiment, all, substantially all, or some of the fluid contacting components may be preassembled so that the fluid conduit passageways and some or all of the associated fittings and componentry are connected as a unit. Then, the mold material can be molded around this unit to provide desired structural stability and/or a desired external shape for mounting to other components.

Further, in some alternative embodiments, the tubing may be made from a material that is removable after the molding process, chemically or otherwise, thus providing the ability not only to use the tubing to form passageways during the molding process, but also to subsequently remove the tubing if desired, still leaving remaining passageways corresponding to the former tubing locations.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method for manufacturing a fluid manifold, comprising:
providing at least one piece of tubing in a mold; and
molding a material into a block around the tubing so that a fluid conduit is formed by the tubing in the block.

2. A method according to claim 1, further comprising the step of bending the piece of tubing before providing it into the mold.

3. A method according to claim 1, wherein the step of providing the tubing includes arranging the tubing so that an end of the tubing projects outside of the molded block.

4. A method according to claim 1, further comprising machining the block after the molding step to form additional passageways that connect to the tubing.

5. A method according to claim 4, further comprising installing at least one of a valve and/or a fitting onto the block to have fluid connection with the tubing.

6. A method according to claim 4, wherein the installing step is after the molding step.
